(19) United States
(12) Patent Application Publication
(10) Pub. No.: US 2004/0057860 A1
(43) Pub. Date: Mar. 25, 2004

(54) Trochoidal pump

(75) Inventors: Masaru Amano, Kiryu-shi (JP); Kenichi Fujiki, Kiryu-shi (JP); Yasunori Ono, Kiryu-shi (JP)

Correspondence Address: McGinn & Gibb, PLLC, Suite 200, 8321 Old Courthouse Road, Vienna, VA, 22182-3817, US

(73) Assignee: Yamada Manufacturing Co., Ltd., Kiryu-shi (JP)

(21) Appl. No.: 10/616,509

(22) Filed: Jul. 10, 2003

(30) Foreign Application Priority Data
Jul. 11, 2002 (JP) 2002-203264
Jun. 19, 2003 (JP) 2003-174279

(51) Int. Cl. F03C 2/00; F03C 4/00; F04C 18/00

(52) U.S. Cl. 418/171

(57) ABSTRACT

To reduce noise caused by pulsation generated when fluid is expelled, in a trochoidal pump comprising an inner rotor and outer rotor having trochoidal toothed shapes.

[Means of Solution] The inner rotor 5 and outer rotor 6 having trochoidal toothed shapes are set in such a manner that when they are in a mutually intermeshing state, a tip clearance d₀ is created between the respective tooth crests 5a of the inner rotor 5 and the outer rotor 6. In at least one position of this group of tip clearances d₀, a large clearance d₁ forming a large interval is provided.

### BACKGROUND OF THE INVENTION

1. Field of the Invention

The present invention relates to a trochoidal pump comprising an inner rotor and an outer rotor having a trochoidal toothed shape, wherein noise caused by pulsation generated when a fluid is discharged can be reduced.

2. Description of the Related Art

A trochoidal pump is widely used as a lubricating oil pump fitted in an automobile engine, or the like. This trochoidal pump is fitted with an inner rotor and an outer rotor having a trochoidal toothed shape. Utility Model No. (Sho)64-56589 discloses a trochoidal pump of this kind, having a composition wherein the rear side face of each tooth of the inner rotor in the direction of rotation is formed into a simple arc about a single central point, and the height of this section is made lower than the tooth shape based on the trochoidal curve.

Furthermore, Japanese Patent Laid-open No. (Hei)2-95787 discloses a pump wherein the faces of the tips of the inner teeth of the outer rotor and the outer teeth of the inner rotor are formed so as to follow a partial circumference of a circular cylinder drawn about the centre of rotation of the respective rotor, the interval between the front ends of the teeth of the inner rotor and the outer rotor, in other words, the tip clearance, which has an effect on the sealing properties, being maintained at a prescribed value, whilst the front faces of the rotor teeth are adjusted. The two foregoing patents specify the shape of the teeth in such a manner that a prescribed tip clearance is set, equally for each of the teeth.

The foregoing disclosures propose devices wherein the shape of the teeth is changed in order to set a prescribed tip clearance equally for each of the teeth, thereby reducing the pulsation of the fluid, reducing the noise, and also increasing the pump performance. Although the noise is certainly restricted by reduction of fluid pulsation, in reducing the pulsation, the state where the fluid is enclosed in the spaces between the inner rotor and outer rotor is eliminated, and furthermore, it becomes necessary to provide a tip clearance between the ends of the teeth of the inner rotor and the outer rotor, in such a manner that the fluid can be introduced into the spaces and expelled therefrom, smoothly and readily.

By setting this tip clearance to a suitable value, it is possible to reduce pulsation and hence to reduce noise. However, increasing the tip clearance simultaneously produces a drawback in that pump performance declines. Moreover, if the tip clearance is set to a small value in order to maintain pump performance, it then becomes difficult to reduce pulsation and noise. It is extremely hard to set up optimum conditions whilst resolving these mutually contradictory conditions.

The prior art technology sets the same prescribed tip clearance equally for each of the respective teeth, and therefore the setting of the tip clearance is important, but since this tip clearance is set uniformly at the respective teeth of the inner rotor and outer rotor when the pump rotates, a systematic pulsation is generated by the uniformly established tip clearances. When the pressurized fluid generating this systematic pulsation is discharged from the pump, resonance is liable to occur in both the pump and the fluid supply device, and it becomes difficult to prevent the generation of noise. The object of the present invention lies in reducing pulsation of this kind whilst at the same time maintaining pump efficiency at a uniform level.

### SUMMARY OF THE INVENTION

Therefore, as a result of thorough study and research with the aim of resolving these problems, the present inventors devised the present invention concerning a trochoidal pump wherein an inner rotor 5 and an outer rotor 6 having trochoidal toothed shapes are provided in a mutually intermeshing state, in such a manner that a tip clearance is created between each tooth crest of the inner rotor 5 and the outer rotor 6, a large clearance forming a large interval being provided in at least one location of the group of said tip clearances, whereby pulsation during expulsion of fluid can be reduced markedly by means of an extremely simple structure, and hence the aforementioned problems are resolved.

### BRIEF DESCRIPTION OF THE DRAWINGS

FIG. 1 is a front view of the present invention;

FIG. 2 is an enlarged view of section (A) in FIG. 1;

FIG. 3 is an enlarged view of section (B) in FIG. 1;

FIG. 4 is a front view of an inner rotor having an even number of teeth according to the present invention;

FIG. 5 is a front view of an outer rotor corresponding to the inner rotor in FIG. 4;

FIG. 6(A) is a front view showing a combined state of an inner rotor having an odd number of teeth and an outer rotor corresponding to this inner rotor and FIG. 6(B) is a front view of an inner rotor having an odd number of teeth;

FIGS. 7(A), (B), (C) are action diagrams showing the operation of the inner rotor and outer rotor when they rotate in a stable state;

FIG. 8 is a graph showing performance in a two-tooth non-uniform composition;

FIG. 9 is a graph showing performance in a three-tooth non-uniform composition;

FIG. 10 is a graph showing performance in a standard value composition;

FIG. 11(A) is a plan view showing the amount of retraction of respective large clearance tips of an inner rotor, FIG. 11(B) is a plan view showing the amount of retraction of respective large clearance tips of an outer rotor and FIG. 11(C) is an enlarged plan view of a maximum clearance formed by the respective large clearance tips of the inner rotor and the outer rotor;

FIG. 12 is an enlarged plan view of a large clearance formed on a large clearance tip which is greater than the respective tip clearances of the inner rotor and outer rotor;

FIG. 13 is an enlarged plan view of a large clearance formed by a large clearance tip on the inner rotor alone;

FIG. 14 is an enlarged plan view of a large clearance formed by a large clearance tip on the outer rotor alone;

FIG. 15(A) is a plan view of an inner rotor wherein the large clearance tips are arranged in a uniform fashion, FIG. 15(B) is a plan view of an inner rotor wherein the large clearance tips are arranged in a non-uniform fashion and FIG. 15(C) is a plan view of an inner rotor wherein the large clearance tips are arranged in a non-uniform fashion according to a different pattern; and

FIG. 16 is a plan view showing the shape of a large clearance tip formed by an inner rotor and outer rotor.

### DESCRIPTION OF THE PREFERRED EMBODIMENTS

Below, embodiments of the present invention are described with reference to the drawings. As shown in FIG. 1, the trochoidal pump according to the present invention comprises an inner rotor 5 and an outer rotor 6 having a trochoidal toothed shape installed in a rotor chamber 1 formed inside a casing, similarly to a general trochoidal pump. The rotor chamber 1 is formed with an intake port 2 and an outlet port 3 extending in the circumferential direction in the vicinity of the outer circumference. The intake port 2 and the outlet port 3 are formed in laterally symmetrical positions about the centre of the rotor chamber 1.

The inner rotor 5 has a number of teeth one fewer than the outer rotor 6, and a relationship is formed whereby each time the inner rotor 5 performs one whole revolution, the outer rotor 6 rotates with a delay equivalent to one tooth behind the inner rotor. In this way, the inner rotor 5 comprises tooth crests 5a which project in an outward direction and concave shaped tooth valleys 5b, and similarly, the outer rotor 6 comprises tooth crests 6a which project towards the centre from the inner circumference thereof, and concave shaped tooth valleys 6b. The inner rotor 5 and outer rotor 6 always intermesh at one point, tooth crests 5a of the inner rotor 5 being introduced into tooth valleys 6b of the outer rotor 6 and tooth crests 6a of the outer rotor 6 being introduced into tooth valleys 5b of the inner rotor 5.

As shown in FIG. 1, a plurality of demarcated spaces s, s, are formed between the inner rotor 5 and the outer rotor 6 when they are operated, and by means of the rotating inner rotor 5 and outer rotor 6, fluid is taken in via the intake port 2 whilst the spaces on the input port 2 side gradually increase in volume, and furthermore, fluid is expelled from the outlet port 3 whilst the spaces s on the outlet port 3 side gradually decrease in volume.

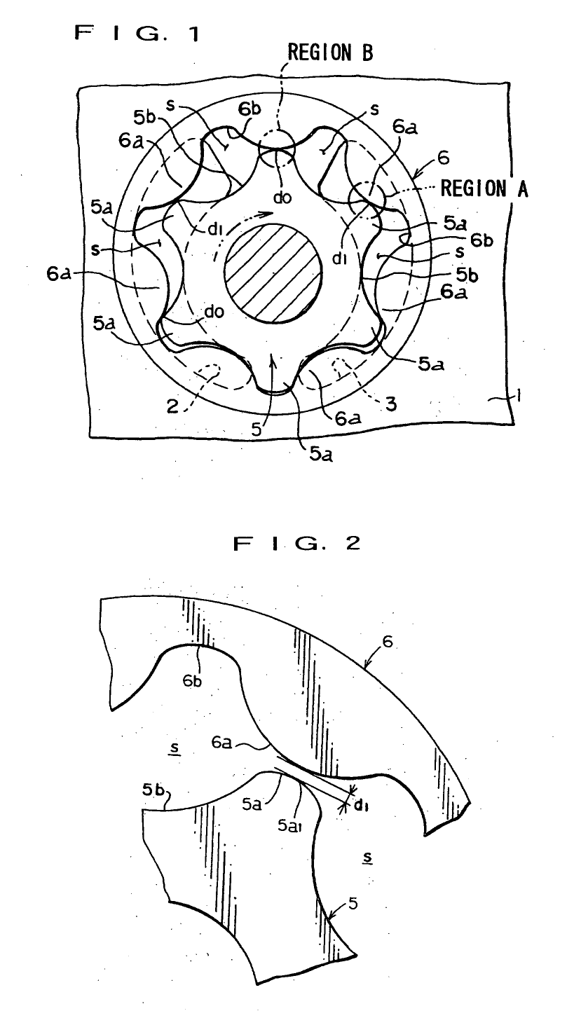

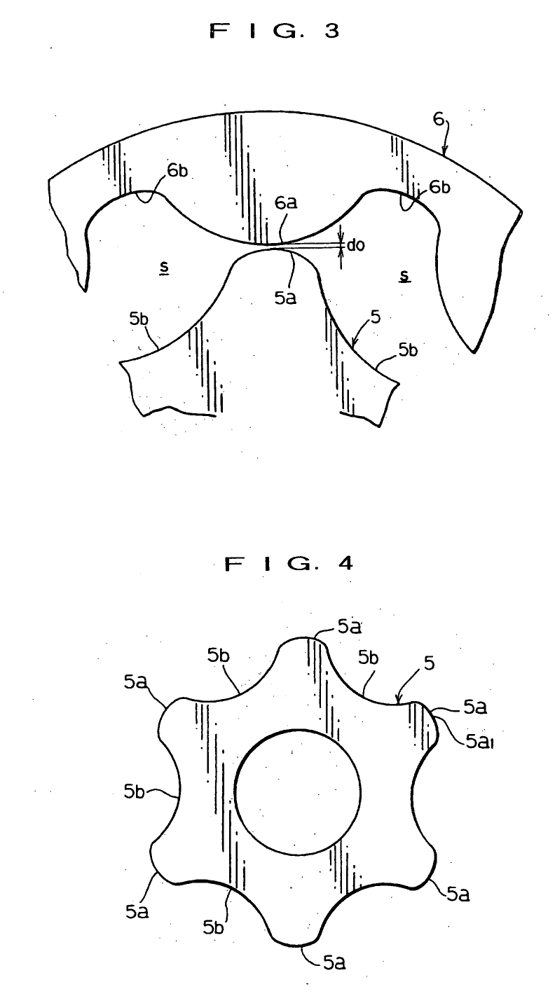

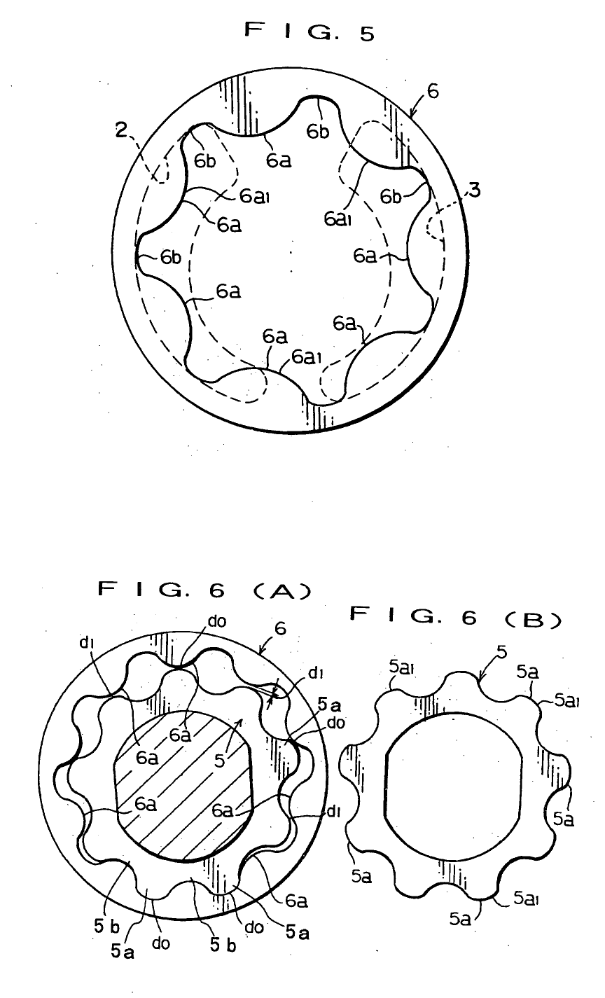

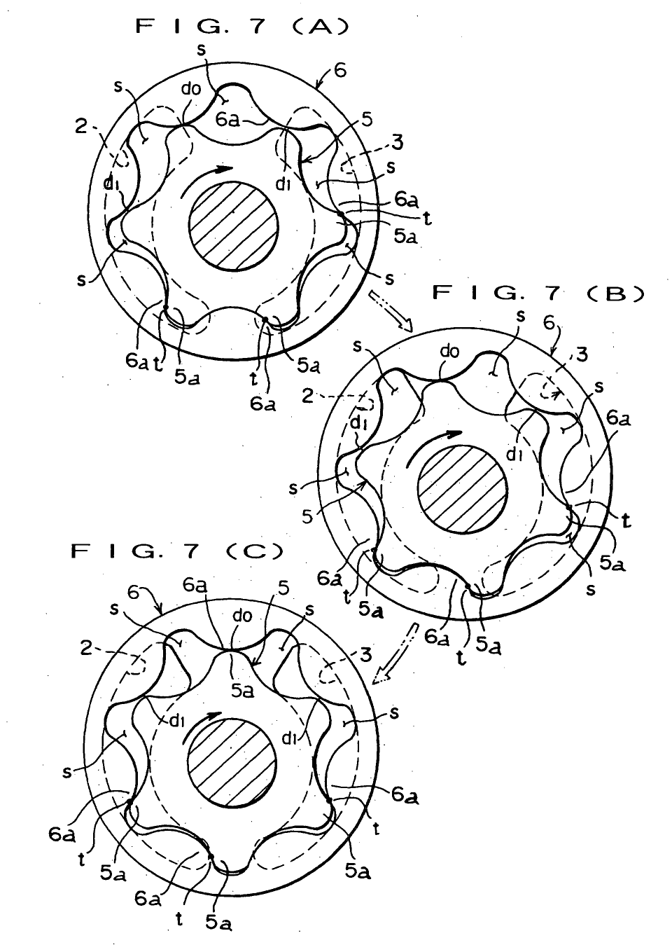

In the trochoidal pump described above, in the shape of the teeth where the inner rotor 5 and outer rotor 6 intermesh, a clearance which is greater than the normally set tip clearance d₀, in other words, a large clearance d₁, is set as illustrated in FIG. 1 and FIG. 2. The tooth crests for achieving this large clearance d₁ are formed on either the outer rotor 6 or the inner rotor 5. In setting a large clearance d₁ of this kind, as shown in FIG. 4, a large clearance tip 5a₁ is formed on a suitable one or plurality of the crest ends of the plurality of tooth crests 5a of the inner rotor 5. Alternatively, as shown in FIG. 5, a large clearance tip 6a₁ is formed on a suitable one or plurality of the crest ends of the plurality of tooth crests 6a of the outer rotor 6. The tooth shape of the large clearance tips 5a₁, 6a₁ is achieved by processing for removing the front end of the tooth crest, or forming a tooth shape having a low front end on the tooth crest when forming the rotor, or the like.

The generally established tip clearance d₀ is set uniformly, and by providing a tooth crest set especially to a large clearance d₁ in the rotor teeth, the tip clearance d₀ of the intermeshing rotors becomes non-uniform. For example, if the tooth crests are set in such a manner that a large clearance d₁ is provided in two places on an inner rotor 5 having four teeth, then the large clearance is provided every other tooth and there will be tooth crests having the normally established tip clearance of d₀ between these tooth crests. Moreover, if tooth crests having a large clearance d₁ are provided in two places in an inner rotor having six teeth, then they will be provided at intervals of three teeth, or an intervals of two teeth and fourth teeth.

If the inner rotor 5 has a number of teeth greater than 6, then the tooth crests set to have a large tip clearance d₀ are set at least every other tooth position, and hence there will be tooth crests having a large tip clearance d₀ set every other tooth position, or at intervals of one teeth and three teeth, as described previously, depending on the number of such teeth set. This applies similarly in cases where the outer rotor 6 has six or more teeth. A tooth crest having a large clearance d₁ should be set in at least one position, but desirably a suitable number of such tooth crests are provided, according to the number of teeth on the rotors. Setting a large clearance d₁ on a rotor having six teeth or more is desirable, since it allows pulsation to be suppressed without reducing volume efficiency.

Tooth crests having an enlarged clearance d₁ make it possible to reduce the number of enclosed space volumes by interconnecting the spatial volumes formed between the intermeshing rotors, thus reducing pulsation, and hence pulsation can be suppressed to a low value. Furthermore, any reduction in volume efficiency caused by interconnection of the spatial volume between the rotors can be restricted by designing the rotors to have six or more teeth. In other words, adjacent spaces s, s are interconnected by means of the large clearance d₁, thereby permitting the passage of fluid and preventing enclosure of the fluid.

Next, if the inner rotor 5 or outer rotor 6 has an even number of teeth, then of the number of rotor teeth n, a number of tooth crests equal to n/2 are set to have a large clearance d₁. The tooth crests formed with a large clearance d₁ are set at the least every other tooth. If the number of teeth n is even, then by setting the number of tooth crests formed with a large clearance d₁ to n/2, it is possible to a well balanced arrangement, and pulsation can be suppressed whilst maintaining volume efficiency.

Furthermore, if the inner rotor 5 or outer rotor 6 has an odd number of teeth, then of the number of rotor teeth n, a number of tooth crests (n−1)/2 are set to have a large clearance d₁, these being disposed at the least every other tooth, similarly to the foregoing description. In the case of an odd number of teeth, the ratio of the number of tooth crests having a standard tip clearance d₀ is set to a larger ratio, and furthermore, the tooth crests formed with a large clearance d₁ are not arranged equidistantly. Since the sequence of the tip clearance d₀ and the large clearance d₁ will be non-regular and non-uniform, and the positioning of the tooth crests having a large clearance d₁ will also be non-uniform, the regularity of the hydraulic pulsation will be disturbed, thus disrupting the resonance, and hence pulsation can be suppressed and volume efficiency can be maintained.

Thereby, the tip clearance d₀ of the rotors ceases to be uniform, and assumes a non-uniform state. The large clearance d₁ moves in accordance with the meshing rotation of the outer rotor 6 and inner rotor 5, thereby changing phase. If the number of large clearances d₁ is more than one, then the positioning thereof may be uniform or non-uniform with respect to the number of rotor teeth, or it may be non-uniform, regardless of the number of rotor teeth.

By selecting the arrangement thereof suitably, the regularity of the hydraulic pulsation of the pump is disturbed, thus making it possible to prevent resonance due to pulsation and to reduce noise. This is now described on the basis of a graph illustrating this effect. Firstly, the value of the hydraulic pulsation plotted on the Y axis is as shown in the graph, the units being decibels (dB). The graph relates to a rotational speed of 2000 rpm. The waveform of the graph is achieved by measuring the frequency of the hydraulic pulsation (the resonance speed).

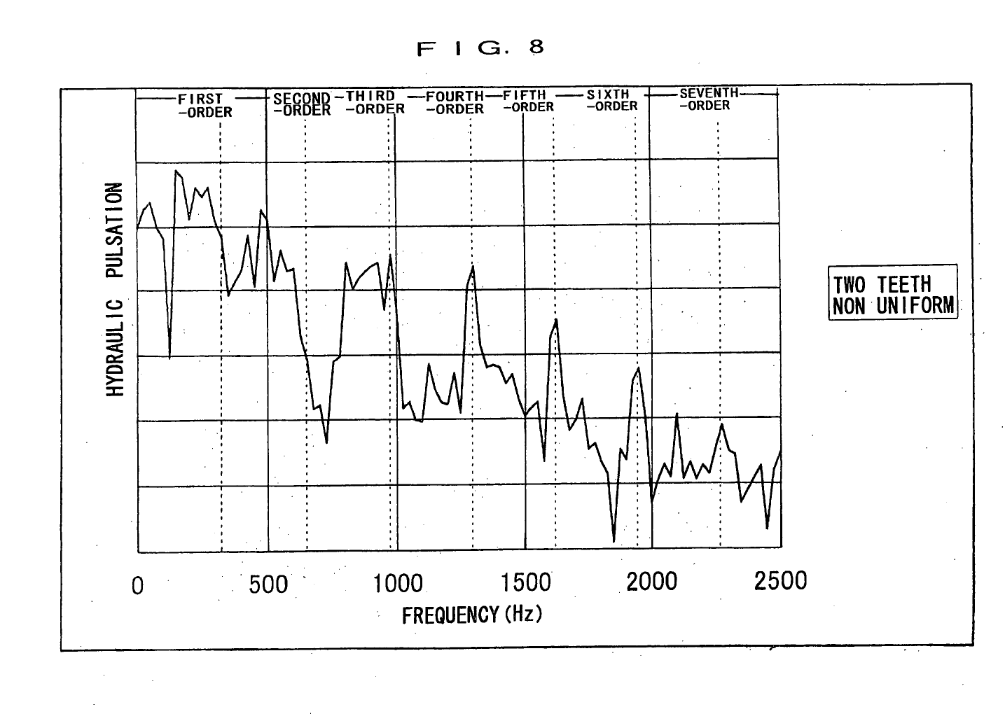

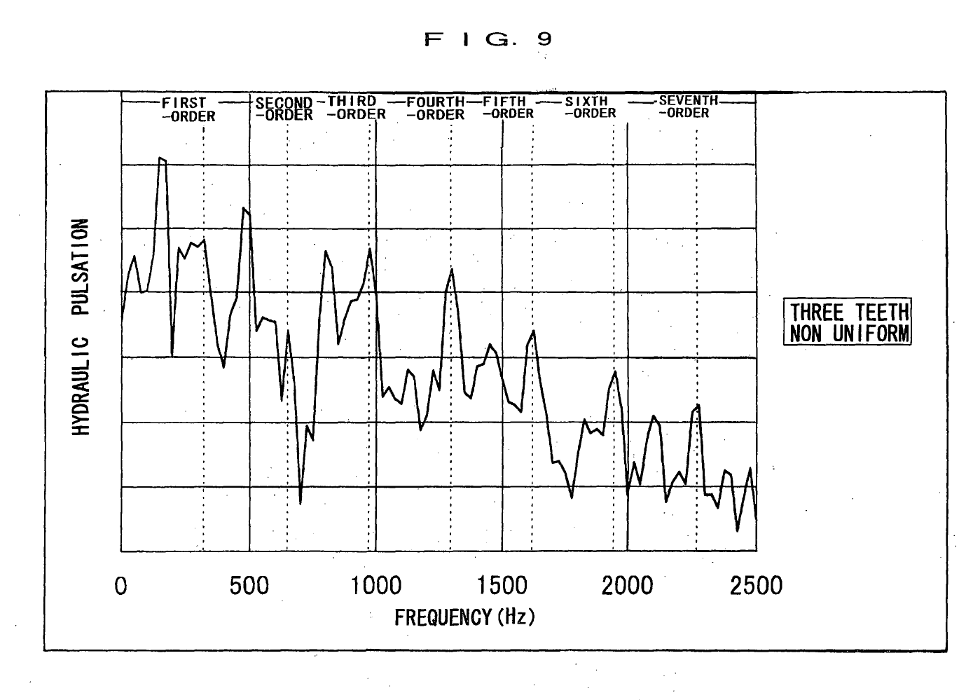

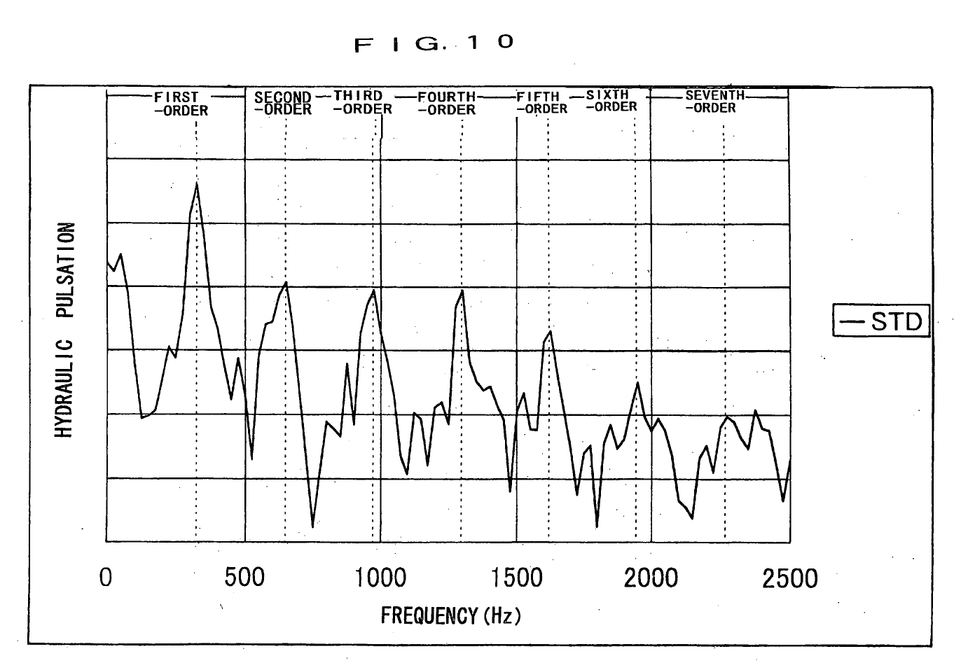

The standard value graph shows data for a normal trochoidal type oil pump. The frequency of the hydraulic pulsations in this graph is determined by the rotational speed of the pump and the number of teeth of the rotors. In this graph specifically, the pump speed is 2000 rpm, the number of teeth n of the inner rotor 5 is 6 and the number of teeth n of the outer rotor 6 is 7, and the graph shows the frequency generated by these rotors. For example, graphs are illustrated for a pump having a standard tip clearance d₀ (standard value) (see FIG. 10), a pump wherein the large clearance d₁ is set in two places (on two teeth) (see FIG. 8), and a pump wherein the large clearance d₁ is set in three places (three teeth) (see FIG. 9), each graph depicting the corresponding state of the hydraulic pulsation.

In these conditions, as shown in FIG. 10, it can be seen that the standard value (STD) graph has a waveform of regular pulsations. The graphs for pumps having a large clearance d₁ on two teeth and three teeth each show a significant variation in waveform compared to the standard value. In addition to the non-uniform positioning of the tip clearancesd₀ and the large clearancesd₁, it can be seen that the variation in waveforms also differs according to the three toothed arrangement wherein a large clearance d₁ is provided every other tooth or the two toothed arrangement wherein it is provided every three teeth.

Next, it can also be seen that the pumps provided with tooth crests formed with large clearances d₁ on two or three teeth achieve a reduction with respect to the oscillation at 324 Hz which is indicated as a frequency where a strong hydraulic pulsation is obtained in the standard value. As shown in FIG. 8 and FIG. 9, in these pumps with two or three teeth having a large clearance, the pulsation is stronger at a lower frequency than 324 Hz. Both the two and three tooth versions have a maximum pulsation at some 175 Hz lower than the standard value. By changing the strongest frequency of the pulsation in the standard value to another, lower, frequency, and increasing the surrounding frequencies, it is possible to suppress the pulsation of particular frequencies which provoke resonance, and at the same time, the oscillation caused by pulsation is prevented from extending into particular frequencies, and hence the sound generated becomes a sound which is not liable to be heard and consequently the noise can be reduced. The tooth crests 5a formed with a large clearance d₁ are tooth crests 5a which have a large clearance d₁ compared to the tooth crests 5a having a standard tip clearance d₀. To describe this in mechanical terms, the standard tip clearance d₀ is the clearance required to achieve a rotational sliding motion whilst respectively sealing the volume spaces created by the intermeshing of the outer rotor 6 and inner rotor 5. On the other hand, the large clearance d₁ is set appropriately to value whereby two volume spaces are connected.

The characteristics of the graph in FIG. 10 illustrating the standard value comprising a standard tip clearance d₀ only are such that a regular pointed waveform is created. This waveform is shown in first, second and third order sections in the graph. The pointed waveform is such that only the particular frequency projects significantly. The graph shows hydraulic pulsation (oscillation), but if this pulsation causes resonance with the oil filter, and the like, via the piping of the pump, thus appearing as sound, then this sound will be a particular sound having the particular frequency which projects in the graph, and it will be heard continually, thus creating an annoying noise.

The graph for the two tooth non-uniform composition (see FIG. 8) shows the waveform in a case where the rotational speed is maintained at a uniform 2000 rpm and the tip clearance d₀ in two of the six tooth crests of the inner rotor 5 is increased to a large clearance of d₁ in a rotor of the standard value (STD) described above.

Looking at the two tooth non-uniform graph, the waveform wherein a particular frequency projects in a peaked shape is reduced in comparison with the standard value. In particular, it can be seen that there is no significantly projecting waveform, as in the first, second and third-order sections of the standard value graph, the frequencies surrounding the first, second and third-order frequencies are also increased, and the projecting state of a particular frequency is eased (see corresponding portions of the graphs). Since a sound is generated at a particular frequency in the standard value design, this sound is readily audible and creates a bothersome noise. In the two tooth non-uniform composition, rather than the sound generated at a particular frequency becoming intensified, the surrounding frequencies are also increased, and hence a variety of sounds are combined together, forming a diverse sound which is not readily audible. As a result, the noise is reduced.

This occurs similarly in the case of the three-tooth non-uniform graph also. A waveform containing somewhat more projecting points than the two tooth non-uniform graph is shown. This is because three of the six tooth crests of the inner rotor 5 are formed with a large clearance d₁ which is greater than the tip clearance d₀ and hence these three tooth crests are disposed every other tooth, and the disturbance of the regularity is reduced, but since the waveform of the adjacent frequencies is increased compared to the standard value (STD), these sounds are combined together, thereby forming a diverse sound which is not readily audible and hence noise is reduced.

To describe how a stable rotational state is obtained in the inner rotor 5 and outer rotor 6, in the driving of the rotors, there are drive intermesh regions in two or three locations from the start end side of the intake port 2 to the finish end side thereof, as shown in FIGS. 7(A) and (B). Of the tooth crest contact regions involved in drive intermesh, there are intermeshing regions where the clearance is the standard tip clearance d₀, and regions where the respective tooth crests d₀ not make contact due to the large clearance d₁. Adjacent spaces, s, s are mutually interconnected via the large clearances d₁, thus reducing the number of enclosed spatial volumes and restricting pulsation. Moreover, in the region of the standard tip clearance d₀, the inner rotor 5 and outer rotor 6 support each other mutually at contact point t caused by the intermeshing of the respective tooth crests of the inner rotor 5 and the outer rotor 6, and hence play in the radial direction of the rotors can be prevented. Thereby, pulsation becomes less liable to occur and a stable rotational state can be achieved. The mutual support between the inner rotor 5 and the outer rotor 6 due to the standard tip clearance d₀ is also performed in the region outside the scope of the intake port 2, as illustrated in FIG. 7(C).

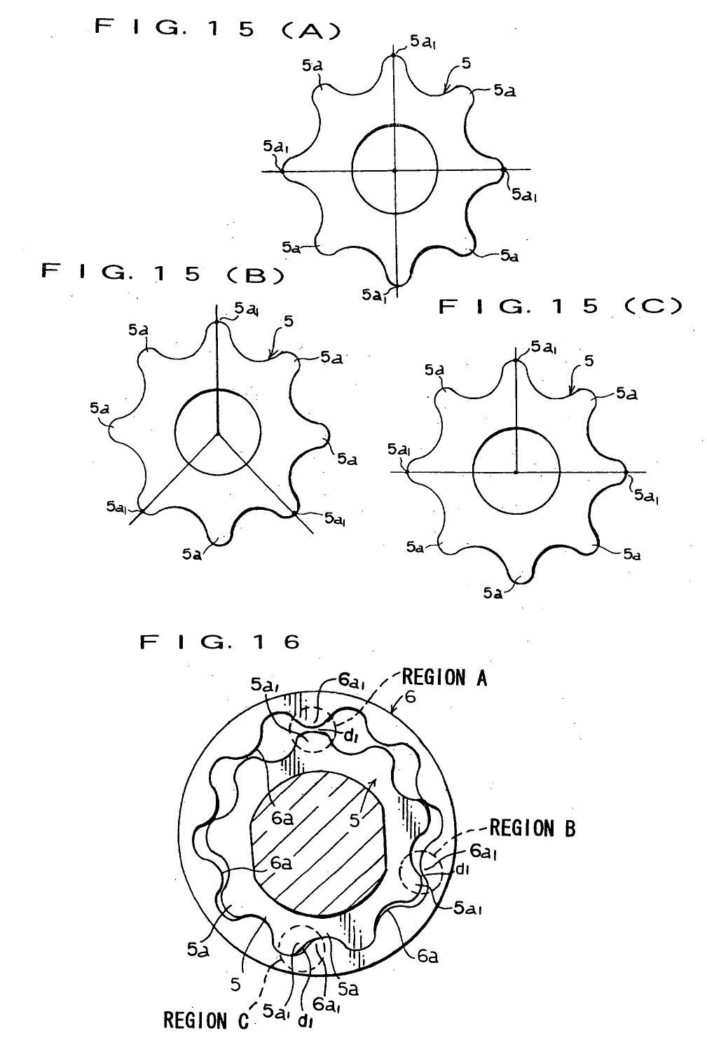

Next, there are two arrangement patterns for the plurality of large clearances d₁, d₁, . . . . In a first pattern, the plurality of large clearances d₁, d₁, . . . are arranged uniformly. For example, as shown in FIG. 15(A), if the number of teeth in the inner rotor 5 is eight, then large clearance tips 5a, on tooth crests 5a formed with a large clearance d, are provided every other tooth.

In a second pattern for arrangement of a plurality of large clearances d₁, d₁, . . . , this plurality of large clearances d₁, d₁, . . . are arranged in a non-uniform fashion. For example, if the inner rotor 5 has eight teeth, similarly to the first pattern, then as shown in FIG. 15(B), after a first large clearance tip 5a₁ where a tooth crest 5a is formed with a large clearance d₁, the next large clearance tip 5a₁ is formed at a spacing of three teeth. Thereupon, the next large clearance tip 5a₁ is formed at a further spacing of two teeth. Moreover, as shown in FIG. 15(C), after a first large clearance tip 5a₁ where a tooth crest 5a is formed with a large clearance d₁, the next large clearance tip 5a₁ may be formed at a spacing of two teeth. Thereupon, the next large clearance tip 5a₁ is formed at a further spacing of four teeth.

In this way, the large clearance tips 5a₁ where tooth crests 5a are provided with a large clearance d₁ are formed appropriately, in such a manner that there is no regularity in the positioning of the large clearance tips 5a₁, 5a₁, . . . forming the large clearances d₁, d₁, . . . . This non-uniform arrangement of the large clearances d₁, d₁, . . . is also performed if the inner rotor 5 has an odd number of teeth.

The patterns where the aforementioned large clearances d₁, d₁, . . . are arranged in uniform or non-uniform fashion were described on the basis of the inner rotor 5, but it is of course possible to base the uniform or non-uniform arrangement pattern of the large clearances d₁, d₁, . . . on the outer rotor 6, and to set the arrangement of the tooth crests 6a, 6a, . . . formed with large clearances d₁, d₁, . . . appropriately. A uniform arrangement of this plurality of large clearances d₁, d₁, . . . is possible in the case of a rotor with six or four teeth, as well as one with eight teeth, but it is conditioned upon the fact that the number of teeth is even.

In the present invention, the large clearance d₁ in the position of region (A) in FIG. 16 is taken to be the same large clearance d₁ as the large clearances d₁ in the positions of regions (B) and (C). In other words, when a space s is formed between the inner rotor 5 and outer rotor 6, if the minimum space between the tooth crest 5a of the inner rotor 5 and the tooth crest 6a of the outer rotor 6 enclosing the space s is greater than the standard tip clearance d₀, then this is taken as a large clearance d₁.

Therefore, in the present invention, the large clearance d₁ at the position where the respective foremost ends of the tooth crest 5a of the inner rotor 5 and the tooth crest 6a of the outer rotor 6 are mutually opposing, as in region (A) in FIG. 16, and the large clearance d₁ at the position where the front crest 5a and front crest 6a are mutually opposing in positions wherein the respective foremost ends thereof are mutually displaced, as in region (B) and region (C) in FIG. 16, are treated as large clearances d₁ of the same conditions. In other words, in the arrangement of the large clearances d₁, d₁, . . . described above, region (A), region (B) and region (C) illustrated in FIG. 16 are mixed together appropriately, and they are distributed in a uniform or non-uniform manner.

Next, in terms of the interval dimensions of the plurality of large clearances d₁, d₁, . . . , there are the following plurality of patterns. Firstly, in a first pattern of interval dimensions, the interval dimensions of all of the large clearances d₁, d₁, . . . formed are taken to be the same. In other words, the respective large clearances d₁, d₁, . . . at region (A), region (B) and region (C) in FIG. 16 all have the mutually equal interval dimensions, as described previously. In this case, the fluid interconnected between the spaces s via the large clearance d₁ is the same in each of the locations of the large clearances d₁, d₁, . . . . Consequently, the non-regularity of the pulsation during operation of the pump is generated at two different positions, those of the tip clearance d₀ and the large clearance d₁, thus producing a simple non-regularity.

Next, in a second pattern for interval dimensions, the interval dimensions of all of the large clearances d₁₁, d₁₂, . . . formed are mutually different, and there exist no large clearances d₁, d₁, . . . which have the same interval dimensions. Here, the addition of suffixes to the large clearances d₁₁, d₁₂, . . . makes it easier to distinguish between the respective large clearances d₁, d₁, . . . , in cases where the interval dimensions thereof are mutually different, as described above. In other words, in this case, the amount of fluid connected between spaces s via the large clearance d₁ is different in each of the respective large clearances d₁₁, d₁₂, . . . . Therefore, the non-regularity of the pulsation during pump operation is generated not only by the tip clearance d₀ and the large clearance d₁, but also by the plurality of different large clearances d₁₁, d₁₂, . . . . In this second pattern of interval dimensions, the non-regularity of the pulsation is enhanced.

Next, in a third pattern of interval dimensions, the interval dimension of at least one large clearance d₁′ of the plurality of large clearances d₁, d₁, . . . formed is different from the interval dimensions of the other large clearances d₁, d₁, . . . . For example, if there are four large clearances d₁, d₁, . . . in a rotor set comprising an inner rotor 5 and outer rotor 6, then one of these large clearances d₁′ is set to a different interval dimension from the other three large clearances d₁, d₁, . . . . In this third pattern of interval dimensions, the non-regularity of pulsation is approximately midway between that of the first pattern and the second pattern. The (′) symbol in the large clearance d₁′ described above is used to distinguish it readily from the other large clearances d₁, d₁, . . . .

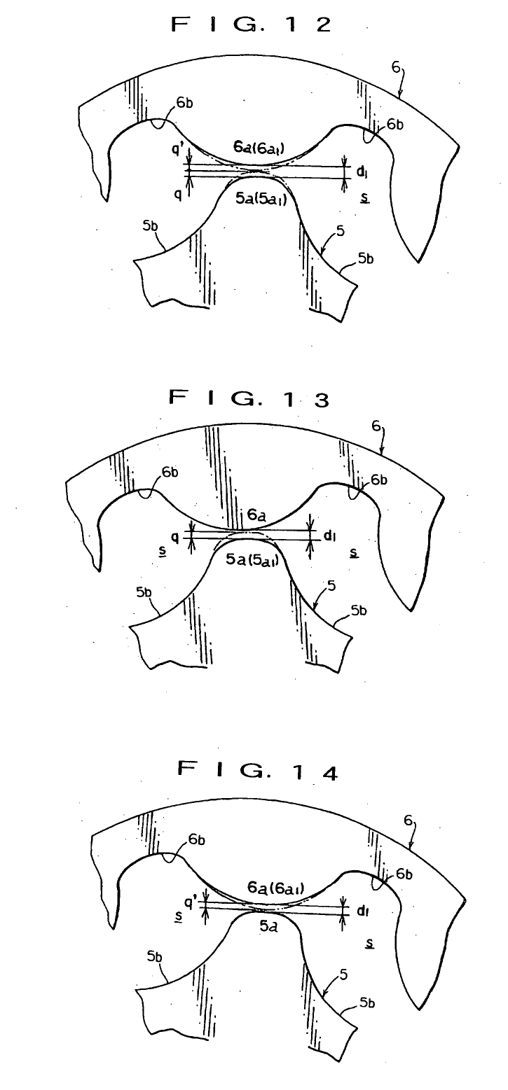

Next, with regard to the formation of the large clearances d₁, d₁, . . . , as described previously, large clearances d₁ are created by forming large clearance tips 5a₁ on tooth crests 5a of the inner rotor 5, or by forming large clearance tips 6a₁ on the tooth crests 6a of the outer rotor. There are a plurality of patterns for forming the large clearances d₁ and in a first formation pattern, the large clearances d₁ are formed only on large clearance tips 5a₁ on the inner rotor 5 (see FIG. 13), or they are formed only on large clearance tips 6a₁ on the outer rotor 6 (see FIG. 14). In this first formation pattern, the large clearances d₁, d₁, . . . are formed in such a manner that all have the same interval dimensions, as described in the interval dimension patterns for the large clearances d₁ mentioned above.

In other words, if the large clearances d₁ are formed only on large clearance tips 5a₁ on the inner rotor 5, then the tooth crests are retracted by an even amount and the plurality of large clearance tips 5a₁, 5a₁, . . . are formed to an even size, whereby the interval dimensions of all of the large clearances d₁, d₁, . . . are made equal, as described above. In this respect, it is also possible to form large clearances d₁, d₁, . . . by setting large clearance tips 6a₁, 6a₁, . . . on the outer rotor to mutually equal size.

Furthermore, in the second formation pattern, the tooth crests 5a are retracted by mutually different amounts, thereby causing the size-of a plurality of large clearance tips 5a₁₁, 5a₁₂, . . . to be mutually different, and hence the interval dimensions of all of the large clearances d₁₁, d₁₂, . . . formed are mutually different, as described previously. In the case of these large clearance tips 5a₁₁, 5a₁₂, . . . , the addition of the suffixes makes it easier to distinguish between a plurality of large clearance tips 5a₁, 5a₁, . . . each of which has been retracted by a different amount.

Moreover, in the third formation pattern, by setting a suitable one large clearance tip 5a₁′ of a plurality of large clearance tips 5a₁₁, 5a₁₂, . . . to a different size to that of the other large clearance tips 5a₁₁, 5a₁₂, . . . , then it is possible to make the interval dimension of at least one large clearance d₁ of the plurality of large clearances d₁₁, d₁₂, . . . differ from the interval dimensions of the other large clearances d₁, d₁, . . . .

In the description of the second and third formation patterns explained above, the large clearances d₁₁, d₁₂, . . . were constituted by forming a plurality of large clearance tips 5a₁₁, 5a₁₂, . . . on the inner rotor 5, but it is also possible to set a plurality of large clearance tips 6a₁₁, 6a₁₂, . . . on the outer rotor 6 to mutually different sizes, or to set a suitable one large clearance tip 6a₁ of a plurality of large clearance tips 6a₁₁, 6a₁₂, . . . on the outer rotor 6 to a different size from the other large clearance tips 6a₁, 6a₁, . . . . The addition of suffixes to the large clearance tips 6a₁₁, 6a₁₂, . . . makes it easier to distinguish between the large clearance tips 6a, 6a, . . . of mutually different sizes.

Moreover, in a fourth formation pattern for the large clearances d₁, d₁, . . . , as shown in FIGS. 11(A) and (B), large clearance tips 5a₁ are formed on tooth crests 5a of the inner rotor 5, and furthermore, large clearance tips 6a₁ are formed on the tooth crests 6a of the outer rotor 6. When a large clearance tip 5a₁ on the inner rotor 5 is opposing a tooth crest 6a on the outer rotor 6, or when a large clearance tip 6a₁ of the outer rotor 6 is opposed a tooth crest 5a of the inner rotor 5, then the aforementioned large clearance d₁ is created, and moreover, when a large clearance tip 5a₁ of the inner rotor 5 is opposing a large clearance tip 6a₁ of the outer rotor 6, then a maximum clearance dₘₐₓ, which is larger than the large clearance d₁, is created.

As shown in FIG. 11(C), this maximum clearance dₘₐₓ is the sum of the greatest amount of retraction q of the large clearance tip 5a₁ and the greatest amount of retraction q′ of the large clearance tip 6a₁, and in terms of an equation, dₘₐₓ=q+q′.

The maximum clearance dₘₐₓ has an interval dimension which is greater than the standard large clearance d₁, in other words, the large clearance d₁ created by the retraction of the circumferential edge of one only of either a tooth crest 5a of the inner rotor 5 or a tooth crest 6a of the outer rotor 6.

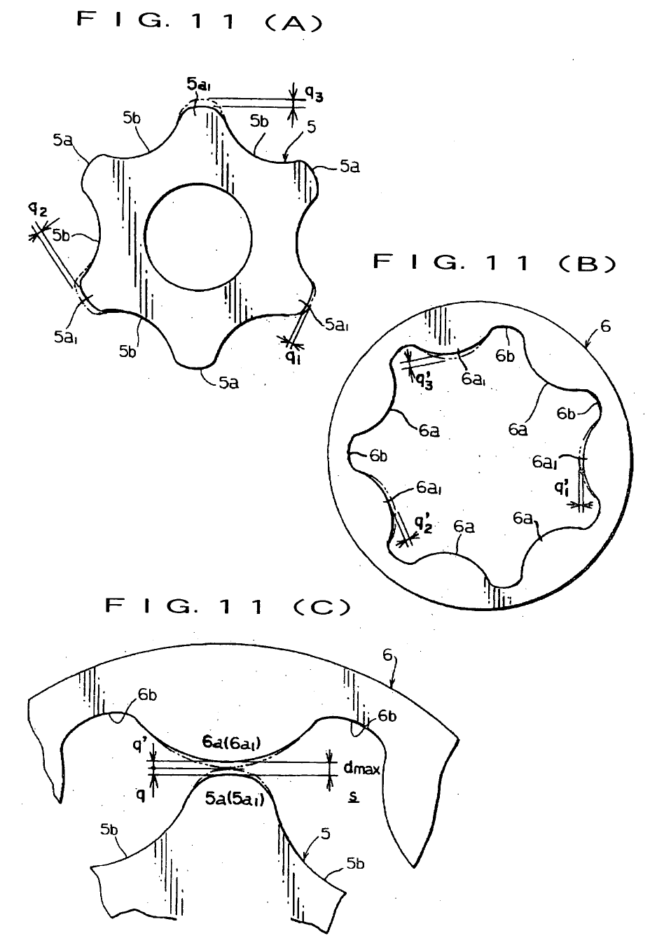

Next, in a fifth formation pattern for the large clearances d₁, d₁, . . . , as shown in FIG. 12, the large clearance d₁ may be formed by means of a large clearance tip 5a₁ on the inner rotor 5 and a large clearance tip 6a₁ on the outer rotor 6.

In the fourth pattern and fifth formation patterns described above, by setting the respective amounts of retraction q, q, . . . of the large clearance tips 5a₁, 5a₁, . . . of the inner rotor 5 to the same or mutually different amounts, and by setting the respective amounts of retraction q′, q′, . . . of the large clearance tips 6a₁, 6a₁, . . . of the outer rotor 6 to the same or mutually different amounts, then it is possible to set the plurality of large clearances d₁₁, d₁₂, . . . formed by these large clearance tips 5a₁, 6a₁ to have respectively the same or mutually different interval dimensions.

For example, if the respective amounts of retraction q₁, q₂, q₃ of the respective large clearance tips 5a₁, 5a₁, . . . on the inner rotor 5 are considered, then the following mutual relationships exist between these respective amounts of retraction.

(1) q=q₂=q₃, (2) q₁≠q₂≠q₃, (3) q₁=q₂≠q₃, (4) q₁≠q₂=q₃, (5) q₁=q₃≠q₂,

Moreover, the relative magnitudes of the retraction amounts q₁, q₂, q₃ are as follows.

(6) q₁>q₂, (7) q₁<q₂, (8) q₂>q₃, (9) q₂<q₃, (10) q₁>q₃, (11) q₁<q₃.

Similarly, if the respective amounts of retraction q₁′, q₂′, q₃′ of the respective large clearance tips 6a₁, 6a₁, . . . on the outer rotor 6 are considered, then the following mutual relationships exist between these respective amounts of retraction.

(1) q₁′=q₂′=q₃′, (2) q₁′≠q₂′≠q₃′, (3) q₁′=q₂′≠q₃′, (4) q₁′≠q₂′=q₃′, (5) q₁′=q₃′≠q₂′,

Moreover, the relative magnitudes of the retraction amounts q₁, q₂, q₃ are as follows.

(6) q₁′>q₂′, (7) q₁′<q₂′, (8) q₂′>q₃′, (9) q₂′<q₃′, (10) q₁′>q₃′, (11) q₁′<q₃′,

In a composition wherein a maximum clearance dₘₐₓ according to the fourth pattern and large clearances d₁ according to the fifth pattern are formed by means of large clearance tips 5a₁ on the inner rotor 5 and large clearance tips 6a₁ on the outer rotor 6, then if the conditions of the amounts of retraction of the large clearance tips 5a₁ on the inner rotor 5 are q₁=q₂=q₃, and the amounts of retraction of the large clearance tips 6a₁ on the outer rotor 6 are q₁′=q₂′=q₃′, the maximum clearance dₘₐₓ and the large clearances d₁ created by the inner rotor 5 and the outer rotor 6 will be uniform values.

Moreover, if the conditions of the amounts of retraction of the inner rotor 5 are taken to be q₁≠q₂≠q₃, and the amounts of retraction of the outer rotor 6 are taken to be q₁′≠q₂≠q₃′, then there will exist various combinations of values for the maximum clearance dₘₐₓ in the fourth pattern and the large clearance d₁ in the fifth pattern, as created by the inner rotor 5 and outer rotor 6.

The maximum clearance dₘₐₓ in the fourth pattern will be of a varying size, whilst the large clearance d₁ in the fifth pattern will be of uniform size.

In other words, in the case of the maximum clearance dₘₐₓ, in the fourth pattern, since the maximum clearance dₘₐₓ and the retraction amounts forming it are different on the inner rotor 5 and the outer rotor 6, large clearances d₁ of a variety of sizes are formed when opposing a tooth crest 5a on the inner rotor or a tooth crest 6a on the outer rotor 6.

Moreover, in the case of the large clearance d₁ in the fifth pattern, although the large clearances d₁ created by the combination of rotors will be of uniform size, since the amounts of retraction forming these clearances are different on the inner rotor 5 and the outer rotor 6, the large clearance d₁ greater than the tip clearance d₀, which is formed when opposing the tooth crest 5a of the inner rotor 5 or the tooth crest 6a of the outer rotor 6, will be of varying size. The combinations of maximum clearance dₘₐₓ in the fourth pattern and the respective amounts of retraction in the large clearance d₁ in the fifth pattern are as described below.

(1) q₁+q₁′, (2) q₁+q₂′, (3) q₁+q₃′,

(4) q₂+q₁′, (5) q₂+q₂′, (6) q₂+q₃′,

(7) q₃+q₁′, (8) q₃+q₂, (9) q₃+q₃′.

The plurality of large clearances d₁, d₁, . . . or the maximum clearance dₘₐₓ are constituted by the aforementioned combinations, and the interval dimensions of the respective large clearances d₁, d₁, . . . based on the respective amounts of retraction described above are respectively different, which means that when the pump operates, since the large clearances d₁, d₁, . . . each have mutually different interval dimensions, it is possible to generate non-regularity in the pulsing action.

The invention according to a first claim concerns a trochoidal pump wherein an inner rotor 5 and an outer rotor 6 having trochoidal toothed shapes are provided in a mutually intermeshing state, in such a manner that a tip clearance d₀ is created between each tooth crest 5a of the inner rotor 5 and the outer rotor 6, a large clearance d₁ forming a large interval being provided in at least one location of the group of the tip clearances d₀, whereby pulsation can be suppressed whilst maintaining volume efficiency.

In other words, there are tip clearances d₀, d₀, . . . between the inner rotor 5 and the outer rotor 6, at least one of this group of tip clearances d₀ being set to a large clearance d₁ forming a large interval, and by including a large clearance d₁ in the group of tip clearances d₀, the regular pulsation generated by a group of tip clearances d₀ only, which in turn causes resonance in the trochoidal pump itself and in the peripheral devices, becomes a pulsation of a non-regular cycle, and hence the aforementioned resonance is prevented and noise can be suppressed to a low level. By consequence, it is also possible greatly to improve the lifespan of both the trochoidal pump and the peripheral devices supplied with fluid by the trochoidal pump.

Moreover, since a large clearance d₁ is simply included in the group of tip clearances d₀ between the inner rotor 5 and outer rotor 6, this composition can be adopted readily. This can be achieved by forming a tooth crest of either the inner rotor 5 or the outer rotor 6 to a slightly lower shape, and hence the aforementioned merits can be obtained by means of an extremely simple composition.

The invention according to a second claim concerns the trochoidal pump of the first claim, wherein the number of teeth of the inner rotor 5 is six or more, and a large clearance d₁ is formed between the inner rotor 5 and the outer rotor 6, on the plurality of tooth crests 5a of the inner rotor 5, at least at every other tooth position, whereby, if the inner rotor 5 (or outer rotor 6) has six or more teeth, the positions at which the clearance created between a tooth crest 5 of the inner rotor and the outer rotor 6 becomes a large clearance d₁ are set to be at least every other tooth position of the inner rotor 5, and by selecting the number and arrangement thereof appropriately, a variety of pump performances can be provided readily. Moreover, if the maximum setting number of three tip clearances d₀ and three large clearances d₁ provided on alternate teeth is adopted, then although the large clearances d₁, d₁, . . . form a tooth shape which does not perform rotational drive of the rotors, since they form an interconnected state during intermeshing of the rotors, they allow a well balanced arrangement of the tip clearances d₀ which maintain rotational drive intermeshing of the rotors, and hence the rotation of the rotors can be stabilized.

In other words, there are drive intermesh sections in two to three positions between the start end side and the finish end side of the intake port 2, and of the tooth crest contact regions involved in drive intermesh, there are intermeshing regions where the clearance is the standard tip clearance d₀, and regions where the respective tooth crests d₀ not make mutual contact due to the large clearance d₁, the adjacent spaces, s, s being mutually interconnected via the large clearances d₁, thus reducing the number of enclosed spatial volumes and restricting pulsation. Moreover, in the region of the standard tip clearance d₀, the inner rotor 5 and outer rotor 6 support each other mutually due to intermeshing between the respective tooth crests of the inner rotor 5 and the outer rotor 6, and hence play in the radial direction of the rotors can be prevented, thereby making pulsation becomes less liable to occur and making it possible to achieve a stable rotational state.

The invention according to the third claim concerns the trochoidal pump according to claims 1 or 2, wherein, taking the number of teeth of the inner rotor 5 or outer rotor 6 as n, large clearances d₁, d₁, . . . are arranged in a uniform or non-uniform fashion on appropriate tooth crests 5a, 6a of the teeth, whereby the large clearances d₁, d₁, . . . are arranged in a uniform or non-uniform fashion, and together with the standard tip clearances do, they are able to generate non-regularity in the pulsation caused by the operation of the pump, thus increasing the degree to which resonance can be prevented and noise can be reduced to a low level.

The invention according to the fourth claim concerns the trochoidal pump according to claim 1, 2 or 3, wherein the number of teeth, n, of the inner rotor 5 is set to an even number, and a large clearance d₁ is provided every other tooth on (n/2) tooth crests, whereby, if the number of teeth, n, of the inner rotor (or the outer rotor 6) is an even number, then the tooth crests forming a large clearance d₁ can be set to be at least in every other tooth position. Therefore, if the number of teeth n is even, the regions formed with a large clearance d₁ can be set to n/2 regions, and a well-balanced arrangement between the tip clearance d₀ and the large clearance d₁ can be achieved, thus making it possible to suppress pulsation whilst maintaining volume efficiency.

The invention according to the fifth claim concerns the trochoidal pump according to claim 1, 2 or 3, wherein the number of teeth, n, of the inner rotor 5 is set to an odd number, and a large clearance d₁ is provided at least every other tooth position or every other two tooth positions, on ((n−1)/2) tooth crests, whereby the sequence of the positions of the tip clearances d₀ and large clearances d₁ becomes non-uniform, rather than being systematic, in addition to which the positioning of the tooth crests having large clearance d₁ becomes non-uniform, thereby disturbing the regularity of the hydraulic pulsations, avoiding resonance, and hence making it possible suppress pulsation whilst ensuring volume efficiency.

The invention according to the sixth claim concerns the trochoidal pump according claim 1, 2, 3, 4 or 5, wherein there are a plurality of the large clearances d₁, and all of these large clearances d₁, d₁, . . . have the same interval dimension, whereby a non-regularity in the pulsation caused when the pump operates can be generated by the standard tip clearances d₀, d₀, . . . and the large clearances d₁, d₁, . . . , and moreover, since the plurality of large clearances d₁, d₁, . . . are formed with the same interval dimensions, the composition becomes extremely simple, and the structure of the inner rotor 5 or outer rotor 6 for forming the large clearances d₁, d₁, . . . can be achieved in a comparatively easy fashion.

The invention according to the seventh claim concerns the trochoidal pump according to claim 1, 2, 3, 4 or 5, wherein there are a plurality of the large clearances d₁, and all of these large clearances d₁, d₁, . . . have mutually different interval dimensions, whereby, in addition to the non-regularity of the pulsation caused by the tip clearances d₀ and the large clearances d₁, the non-regularity of the pulsation caused when the pump operates is further increased by the non-regularity of the pulsation caused by the plurality of large clearances d₁, thereby increasing the degree to which resonance can be prevented and noise can be reduced to a low level.

The invention according to the eighth claim concerns the trochoidal pump according to claim 1, 2, 3, 4, or 5, wherein there are a plurality of the large clearances d₁, and at least one of all of these large clearances d₁, d₁, . . . has a different interval dimension to the other large clearances d₁, whereby, in addition to the non-regularity of the pulsation caused by the tip clearances d₀ and the large clearances d₁, since at least one large clearance d₁ of the plurality of large clearances d₁, d₁, . . . has a different interval dimension to the other large clearances d₁, it is also possible to generate non-regularity in the pulsation by means of the large clearances d₁, d₁, . . . alone, thus increasing the degree to which resonance can be prevented and the noise can be suppressed to a low level.

The invention according to the ninth claim concerns the trochoidal pump according to claim 1, 2, 3, 4, 5, 6, 7 or 8, wherein the large clearances d₁ are formed by retracting the circumferential edges of either tooth crests 5a of the inner rotor 5 or tooth crests 6a of the outer rotor 6, whereby the structure can be achieved in an extremely easy fashion, since the circumferential edges of tooth crests of either the inner rotor 5 or outer rotor 6 are retracted.

The invention according to the tenth claim concerns the trochoidal pump according to claim 1, 2, 3, 4, 5, 6, 7 or 8, wherein the large clearances d₁ are formed by retracting the circumferential edges of both tooth crests 5a of the inner rotor 5 and tooth crests 6a of the outer rotor 6, whereby there will exist large clearances d₁ of the plurality of large clearances d₁, d₁, . . . , which are formed by a large clearance tip 5a₁ of the inner rotor 5 and a large clearance tip 6a₁ of the outer rotor 6.

If a large clearance tip 5a₁ and large clearance tip 6a₁ become mutually opposing due to rotation of the rotors, then a particularly big large clearance d₁ (in other words, a maximum clearance dₘₐₓ) will occur amongst the large clearances d₁, d₁, . . . , and by retracting the tooth crests 5a of the inner rotor 5 and the tooth crests 6a of the outer rotor appropriately, it is possible to provide large clearances d₁ of a variety of sizes, whereby the non-regularity of the pulsation caused by pump operation becomes even more pronounced, thus increasing the degree to which the resonance can be prevented and noise can be reduced to a low level. In the foregoing case, dₘₐₓ=q+q′.

Moreover, when a large clearance tip 5a₁ and a large clearance tip 6a₁ oppose each other due to rotation of the rotors, large clearances d₁, d₁, . . . are formed, and when a tooth crest 5a of the inner rotor 5 or a tooth crest 6a of the outer rotor 6 opposes such a large clearance tip 5a₁ or large clearance tip 6a₁, then a large clearance d₁ which is greater than the tip clearance d₀ but smaller than the aforementioned large clearance d₁ (equal to the maximum clearance dₘₐₓ) is formed, whereby the large clearance d₁ can be set to a variety of sizes by means of retracting the tooth crests 5a of the inner rotor 5 and the tooth crests 6a of the outer rotor 6 by appropriate amounts, thus enhancing the non-regularity of the pulsation during pump operations, and increasing the degree to which resonance can be prevented and noise reduced to a low level. In the foregoing, d₁=q+q′.

What is claimed is:

1. A trochoidal pump characterized in that an inner rotor 5 and an outer rotor 6 having trochoidal toothed shapes are provided in a mutually intermeshing state, in such a manner that a tip clearance is created between each tooth crest of the inner rotor 5 and the outer rotor 6, a large clearance forming a large interval being provided in at least one location of the group of said tip clearances.

2. The trochoidal pump according to claim 1, characterized in that the number of teeth of said inner rotor 5 is six or more, and a large clearance is formed between said inner rotor 5 and said outer rotor 6, on the plurality of tooth crests of said inner rotor 5, at least at every other tooth position.

3. The trochoidal pump according to claims 1 or 2, characterized in that, taking the number of teeth of said inner rotor 5 or outer rotor 6 as n, large clearances d₁, d₁, . . . are arranged in a uniform or non-uniform fashion on appropriate tooth crests 5a, 6a of said teeth.

4. The trochoidal pump according to claim 1, 2 or 3, characterized in that the number of teeth, n, of said inner rotor 5 is set to an even number, and a large clearance is provided every other tooth on (n/2) tooth crests.

5. The trochoidal pump according to claim 1, 2 or 3, characterized in that the number of teeth, n, of said inner rotor 5 is set to an odd number, and a large clearance d₁ is provided at least every other tooth position or every other two tooth positions, on ((n−1)/2) tooth crests.

6. The trochoidal pump according claim 1, 2, 3, 4 or 5, characterized in that there are a plurality of said large clearances d₁, and all of these large clearances d₁, d₁, . . . have the same interval dimension.

7. The trochoidal pump according to claim 1, 2, 3, 4 or 5, characterized in that there are a plurality of said large clearances d₁, and all of these large clearances d₁, d₁, . . . have mutually different interval dimensions.

8. The trochoidal pump according to claim 1, 2, 3, 4, or 5, characterized in that there are a plurality of said large clearances d₁, and at least one of all of these large clearances d₁, d₁, . . . has a different interval dimension to the other large clearances d₁.

9. The trochoidal pump according to claim 1, 2, 3, 4, 5, 6, 7 or 8, characterized in that said large clearances d₁ are formed by retracting the circumferential edges of either tooth crests 5a of said inner rotor 5 or tooth crests 6a of the outer rotor 6.

10. The trochoidal pump according to claim 1, 2, 3, 4, 5, 6, 7 or 8, characterized in that said large clearances d₁ are formed by retracting the circumferential edges of both tooth crests 5a of said inner rotor 5 and tooth crests 6a of the outer rotor 6.
